(19) United States
(12) Patent Application Publication
(10) Pub. No.: US 2017/0274704 A1
(43) Pub. Date: Sep. 28, 2017

(54) VEHICLE WITH VARIABLE CASTER ANGLE

(71) Applicant: CNH Industrial America LLC, New Holland, PA (US)

(72) Inventor: Jeffrey B. Fay, II, Wilmington, DE (US)

(73) Assignee: CNH Industrial America LLC, New Holland, PA (US)

(21) Appl. No.: 15/076,816

(22) Filed: Mar. 22, 2016

(51) Int. Cl. B60B 33/00; B62D 21/09; A01D 41/12; B60B 33/02

(52) U.S. Cl. CPC B60B 33/006; B60B 33/02; B62D 21/09; A01D 41/1243

(57) ABSTRACT

A work vehicle includes a chassis; a primary wheel carried by the chassis; and a caster assembly carried by the chassis. The caster assembly includes a pivotable swivel structure defining a caster angle; and a caster wheel swivelly linked to the swivel structure and defining a wheelbase relative to the primary wheel. A change in the wheelbase passively causes the swivel structure to pivot and change the caster angle.

### BACKGROUND OF THE INVENTION

1. Field of the Invention

The present invention relates to work vehicles, and, more particularly, to agricultural vehicles such as self-propelled windrowers.

2. Description of the Related Art

Self-propelled windrowers are utilized by farmers to cut crop material as the windrower advances across a field and arrange the cut crop material into windrows, which are deposited onto the field behind the windrower to dry. Typical windrowers have a header at the front which will cut the crop material and are driven by a pair of primary wheels linked to a power source, such as an internal combustion engine. The windrower can also include a pair of caster wheels at the rear of the windrower.

When the rear wheels are caster wheels, stability of the windrower is a concern, especially during high speeds such as when the windrower is road traveling. To achieve stability at high speeds, the caster wheels can have varying degrees of caster relative to the ground plane. As is known, the caster angle is the angular displacement from the vertical axis of the suspension of the windrower. At sufficiently high caster angles, such as 9 degrees, it has been found that the caster wheels have adequate stability for high speed travel.

One problem with using high caster angles for stability arises when the windrower is reversing. The geometry of known solutions used to provide high speed stability results in rising of the rear end greater than six inches during reverse direction travel of the windrower. This rising of the rear end results in severe lowering of the header during operation, which can negatively affect standing windrows and also reduce clearance height for header removal and transport deployment.

What is needed in the art is a caster wheel assembly that can adjust the caster angle of the caster wheels while maintaining a constant rear ride height.

### SUMMARY OF THE INVENTION

The present invention provides a vehicle with a caster assembly including a pivotable swivel structure defining a caster angle and a caster wheel linked to the swivel structure such that a change in wheelbase of the vehicle passively causes the caster angle to be changed by the swivel structure pivoting.

The invention in one form is directed to a work vehicle including a chassis; a primary wheel carried by the chassis; and a caster assembly carried by the chassis. The caster assembly includes a pivotable swivel structure defining a caster angle; and a caster wheel swivelly linked to the swivel structure and defining a wheelbase relative to the primary wheel. A change in the wheelbase passively causes the swivel structure to pivot and change the caster angle.

The invention in another form is directed to an agricultural vehicle including a chassis; a header carried by the chassis at a front of the vehicle; a primary wheel carried by the chassis; and a caster assembly carried by the chassis behind the primary wheel. The caster assembly includes a pivotable swivel structure carried by the chassis and defining a caster angle; and a caster wheel swivelly linked to the swivel structure and defining a wheelbase relative to the primary wheel. A change in the wheelbase passively causes the swivel structure to pivot and change the caster angle.

An advantage of the present invention is the rear ride height of the vehicle can be kept substantially constant when the vehicle is reversing.

Another advantage is the caster angle is changed passively so that no additional power from any vehicle systems is necessary to change the caster angle.

Yet another advantage is the caster wheel assembly can include a torsion element to maintain a desired caster angle when the caster wheel is unloaded.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an embodiment of an agricultural vehicle according to the present invention when the vehicle is moving forward;

FIG. 2 is a perspective view of an embodiment of a caster assembly formed according to the present invention in the vehicle shown in FIG. 1;

FIG. 3 is a perspective view of the agricultural vehicle shown in FIG. 1 when the vehicle is moving in reverse;

FIG. 4 is a perspective view of the caster assembly shown in FIG. 2 when the vehicle is moving in reverse;

FIG. 5 is a perspective view of the caster assembly shown in FIG. 4 with a housing plate removed;

FIG. 6 is a side view of an embodiment of a windrower formed according to the present invention illustrating the caster angles and constant rear ride height compared to a prior art caster assembly illustrated in dashed lines

FIG. 7 is a sectional view of a portion of the caster assembly shown in FIGS. 1-6 connected to a lateral end of an axle; and

FIG. 8 is a sectional view of a portion of the caster assembly shown in FIGS. 1-7.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

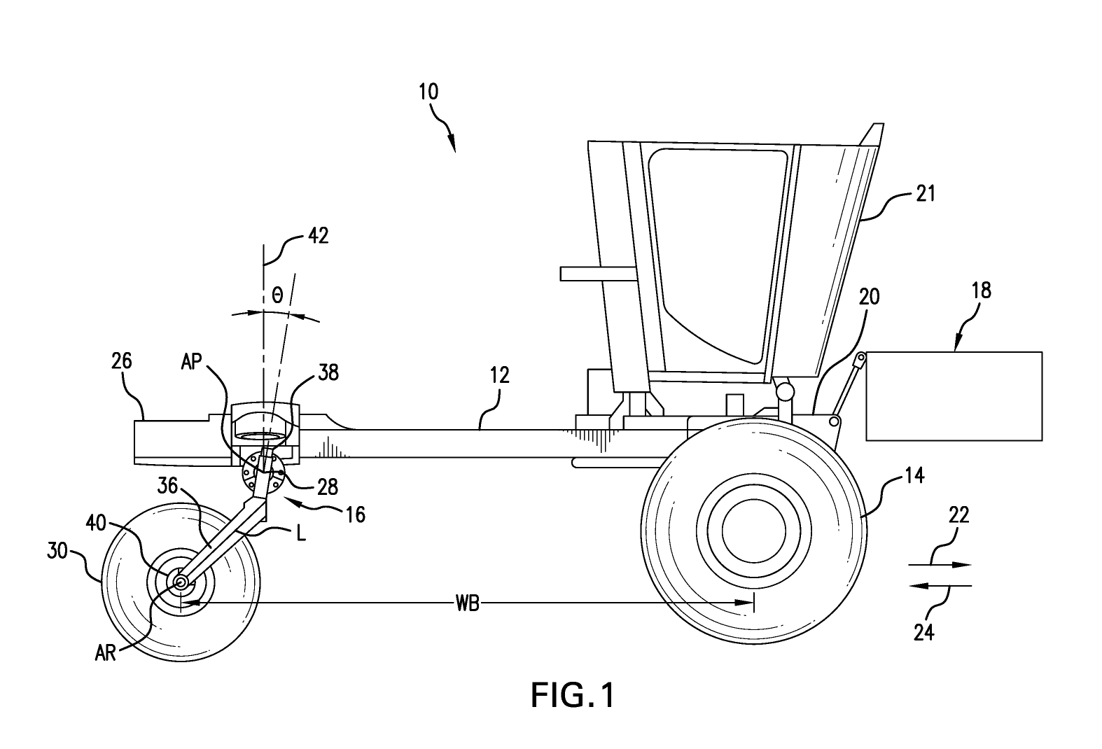

Referring now to the drawings, and more particularly to FIG. 1, there is shown a work vehicle 10, illustrated as a self-propelled windrower, which generally includes a chassis 12, a primary wheel 14 carried by the chassis 12, and a caster assembly 16 also carried by the chassis 12. As can be seen, the work vehicle 10, when in the embodiment of a self-propelled windrower, also includes a header 18 at a front 20 of the vehicle 10. The header 18 is illustrated as a block to represent that the header 18 can be any type of suitable construction for removing crop material from a field, with many such constructions known. A cab 21 can also be carried by the chassis 12 adjacent to the front 20 of the vehicle 10 that provides seating and controls for an operator to utilize during operation of the work vehicle 10.

As shown, the primary wheel 14 is carried by the chassis 12 adjacent the front 20 of the vehicle 10 behind the header 18. The primary wheel 14 is a flotation type wheel and can be linked to a power source (not shown), such as an internal combustion engine, by a transmission (not shown) to propel the vehicle 10 in a forward direction 22 and/or a reverse direction 24. It should be appreciated that all references to “forward” and “reverse” are for convenience of description only and not intended to limit the scope of the invention. While only one primary wheel 14 is shown in FIG. 1, there will typically be another primary wheel 14 on the other side of the vehicle 10, although this is not necessary. The primary wheel(s) 14 can also be connected to a steering mechanism (not shown) to allow the operator to control the forward travel of the vehicle 10, as is known.

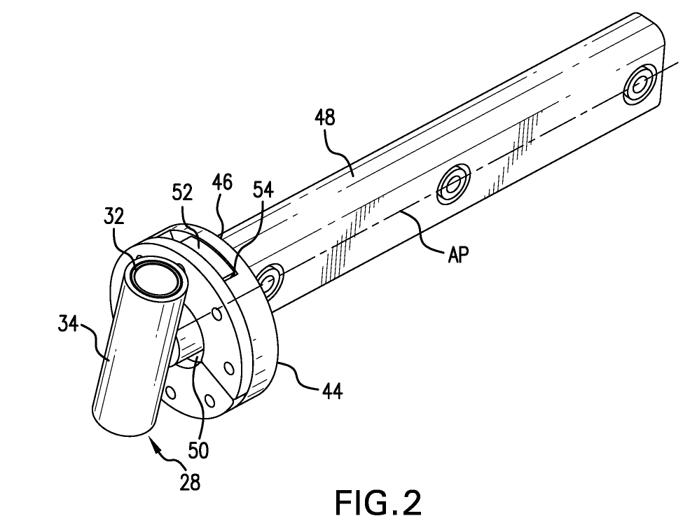

The caster assembly 16 can be carried by the chassis 12 adjacent a rear 26 of the vehicle 10 and includes a swivel structure 28 and a caster wheel 30 that is swivelly linked to the swivel structure 28. With further reference to FIG. 2, it can be seen that the swivel structure 28 can include an inner tube 32 concentrically held within an outer tube 34, with a swivel arm 36 connected to the caster wheel 30 and a swivel post 38 that rotates within the inner tube 32. As can be seen, the swivel arm 36 can connect to the caster wheel 30 at a caster axle 40 which defines an axis of rotation AR of the caster wheel 30, with a length L of the swivel arm 36 between the caster axle 40 and swivel post 38 being constant. The significance of this constant length L of the swivel arm 36 will be described further herein. The swivel structure 28 defines a caster angle θ relative to an imaginary vertical line of the suspension, designated by a line with reference numeral 42, with the angular positioning of the caster wheel 30 relative to the vertical line 42 being dictated by the caster angle θ defined by the swivel structure 28. The caster angle θ shown in FIG. 1 is approximately −9 degrees relative to the vertical line 42, but it should be appreciated the caster angle θ of the swivel structure 28 can be adjusted to give the desired stability characteristics to the vehicle 10. It should be appreciated that, as shown in FIG. 1, the angle formed between the axis of rotation AR of the caster wheel 30 and the vertical line 42 is not the same as the caster angle θ defined by the swivel structure 28 due to the geometry of the swivel arm 36 connecting the caster wheel 30 to the swivel post 38 which rotates in the swivel structure 28. However, since the angle of the caster wheel 30 relative to the swivel structure 28 is constant due to a constant arm length L, changing the caster angle θ defined by the swivel structure 28 will also similarly change the angle of the axis of rotation AR of the caster wheel 30 relative to the vertical line 42.

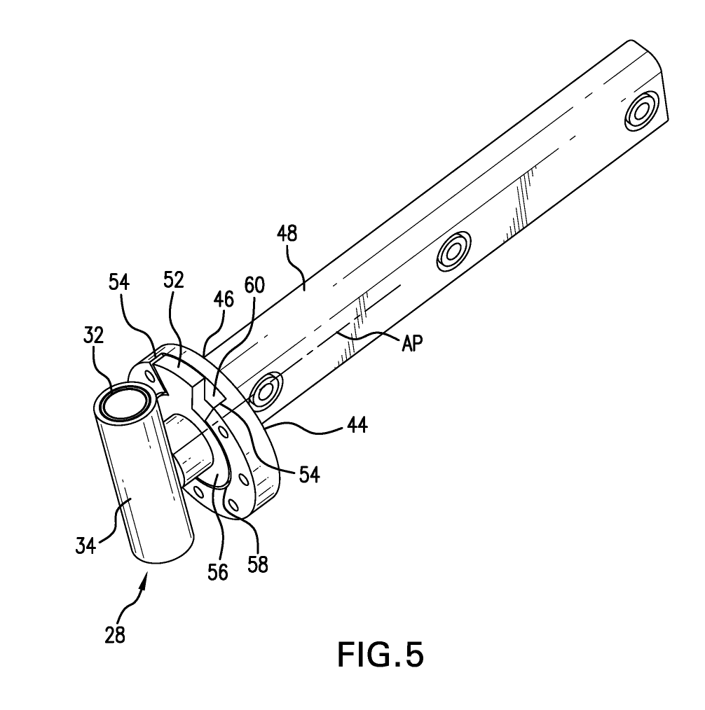

Referring now to FIG. 2, it can be seen that the caster assembly 16 can include a housing 44 connected to a lateral end 46 of a rear axle 48 of a suspension of the vehicle 10 and a pivotable element 50 housed within the housing 44. The swivel structure 28 can be linked to the pivotable element 50 so that as a moment developed by weight on the caster wheel 30 acts on the swivel structure 28, the swivel structure 28 causes the pivotable element 50 to pivot within the housing 44 about a pivoting axis AP. The pivoting axis AP can be collinear with an axis of the rear axle 48 of the suspension. To limit the pivoting range of the pivotable element 50, the pivotable element 50 can include a stop tab 52 that pivots into a stop surface 54 of the housing 44 and prevents further pivoting of the pivotable element 50. As can be seen in FIG. 5, the pivotable element 50 can include a disc 56 placed within a disc groove 58 formed in the housing 44, with the stop tab 52 radially extending from the disc 56 so rotation of the disc 56 about the pivoting axis AP causes the stop tab 52 to contact the stop surface 54 of the housing 44 and prevent further pivoting of the disc 56.

Referring back to FIG. 1, it can be seen that the axis of rotation AR of the caster wheel 30 is behind the pivoting axis AP in the forward travel direction 22 of the vehicle 10. As the caster wheel 30 is a lowest point of the vehicle 10, some of the weight of the vehicle 10 will be supported by the caster wheel 30, generating a moment due to a distance between the vertical line 42 and the vertical vector of the weight supported by the caster wheel 30. This generated moment causes the swivel structure 28 to pivot clockwise relative to the pivoting axis AP. Due to the linkage between the swivel structure 28 and the disc 56, the disc 56 is also pivoted clockwise until the stop tab 52 is pivoted into the stop surface 54, preventing further pivoting of the disc 56 and linked swivel structure 28. Once the stop tab 52 is prevented from further pivoting, the caster angle θ defined by the swivel structure 28 is set and will tend to stay in that orientation.

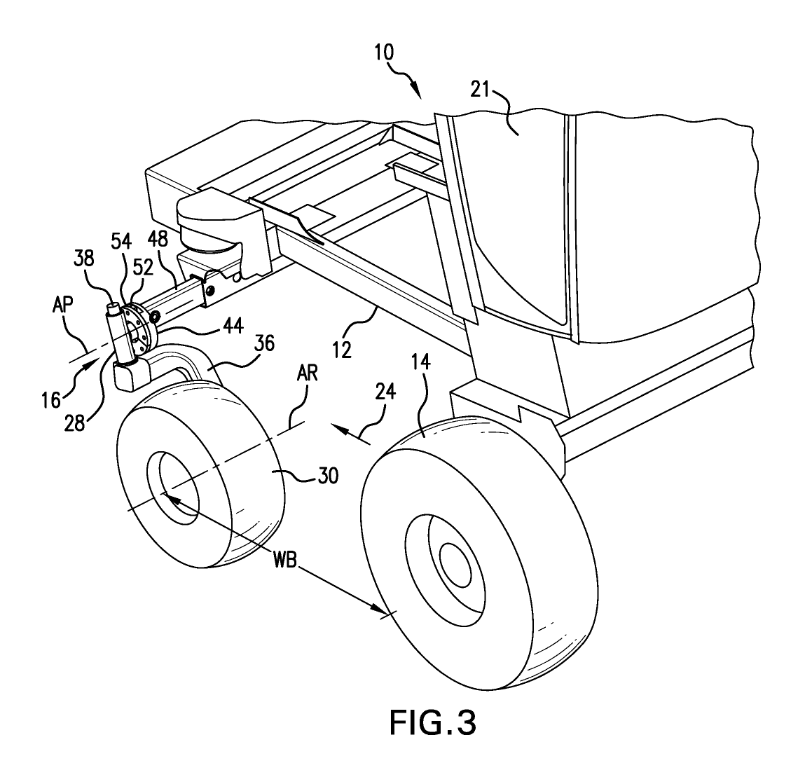

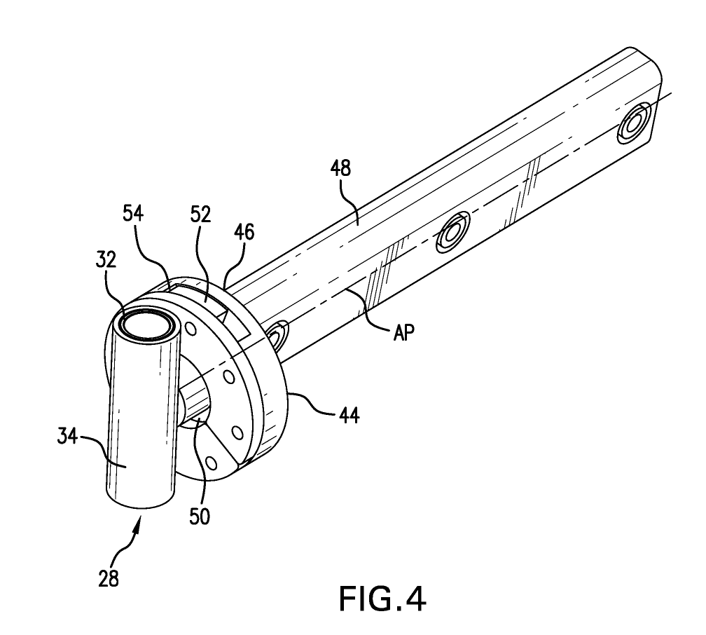

Referring now to FIGS. 3-4, the vehicle 10 is shown when the vehicle 10 is moving in the reverse direction 24. As can be seen, the caster wheel 30 has rotated about the swivel structure 28 by the swivel post 38 rotating within the inner tube 32. As the vehicle 10 moves in the reverse direction 24, the profile of the caster wheel 30 causes the rotation of the swivel post 38 within the inner tube 32 to swivel the caster wheel 30 about the swivel structure 28. When this occurs, the axis of rotation AR of the caster wheel 30 moves in front of the pivoting axis AP of the swivel structure 28. After the axis of rotation AR of the caster wheel 30 moves in front of the pivoting axis AP, the weight supported by the caster wheel 30 produces a moment relative to the vertical line 42, similarly to when the vehicle 10 is moving in the forward direction 22. This produced moment causes the pivotable element 50 to pivot counter-clockwise within the housing 44 until the stop tab 52 pivots into the other stop surface 54 of the housing 44, preventing further pivoting of the disc 56. As shown in FIG. 3, the caster angle θ is +9 degrees, an equal but opposite magnitude to the caster angle θ when the vehicle 10 moves in the forward direction 22, but can be greater or less than +9 degrees if desired. It should therefore be appreciated that changes in a wheelbase WB defined between the caster wheel 30 and primary wheel 14 produce differing moments between the caster wheel 30 and the vertical line 42, passively causing the swivel structure 28 to pivot about the pivot axis AP and changing the caster angle θ. As used herein, “passive” refers to the pivoting of the swivel structure 28 about the pivot axis AP not requiring a vehicle-powered element to produce the pivoting, as opposed to an “active” pivoting where an element requires power from a component of the vehicle 10 to actively produce the pivoting. Further, the wheelbase WB is defined as the distance between the centers of the primary wheel 14 and caster wheel 30.

In comparing FIGS. 2 and 4, it can be seen that the pivoting of the pivotable element 50 within the housing 44 controls the caster angle θ defined by the swivel structure 28. Referring now to FIG. 5, the housing 44 is shown with a plate removed and the pivotable element 50 placed within. Since the pivoting of the disc 56, which is caused by pivoting of the swivel structure 28, is limited by the stop tab 52 contacting the stop surfaces 54, a tab groove 60 formed in the housing 44 can control the caster angle θ defined by the swivel structure 28 in response to changes in the wheelbase WB. When the vertical line 42 is perpendicular to the pivot axis AP of the swivel structure 28, as shown, the housing 44 can be formed as a circular disc with a center that is coincident with the pivot axis AP. The tab groove 60 can be formed as a groove in the circumferential surface of the housing 44 connected to the disc groove 58. In such a configuration, the tab groove 60 can be formed with a center on the vertical line 42, corresponding to a caster angle θ of 0 degrees, with each stop surface 54 of the housing 44 being equidistant from the center of the tab groove 60. This allows the disc 56, and linked swivel structure 28, to pivot an equal distance either clockwise or counter-clockwise, so the caster angle θ defined by the swivel structure 28 is equal in magnitude but opposite between the vehicle 10 moving in the forward direction 22 and reverse direction 24. Alternatively, there may be instances where it is desired to have the caster angle θ have differing magnitudes as the vehicle 10 moves in the forward direction 22 and reverse direction 24. In such instances, the center of the tab groove 60 can be offset from the vertical line 42 and/or the distance of the stop surfaces 54 from the center of the tab groove 60 can be made different so the resulting caster angle θ defined by the swivel structure 28 will not be equal upon the disc 56 pivoting until the stop tab 52 contacts a stop surface 54.

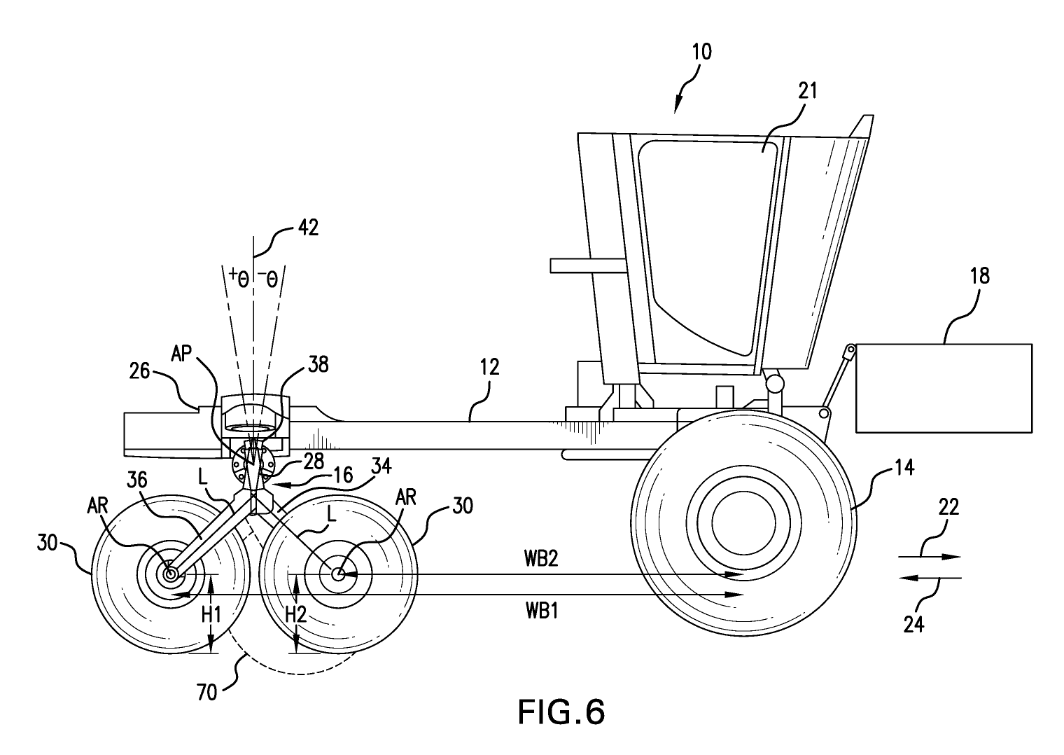

With reference now to FIG. 6, the work vehicle 10 is illustrated with the caster wheel 30 illustrated in solid lines to show both the forward position (caster angle −θ of −9 degrees) and the reverse position (caster angle +θ of +9 degrees), as well as a caster wheel 70 of a prior art caster assembly to illustrate the effect that the swivel structure 28 pivoting has on the handling characteristics of the vehicle 10. To illustrate the change in wheelbase WB of the vehicle 10, a forward wheelbase WB1 illustrates the wheelbase when the vehicle 10 travels in the forward direction 22 and a reverse wheelbase WB2 illustrates the wheelbase when the vehicle 10 travels in the reverse direction. As can be seen in comparing the forward and reverse positions of the caster wheel 30, with the caster wheel 30 having a forward height H1 in the forward travel direction 22 and a reverse height H2 in the reverse travel direction 24, the heights H1, H2 between the axis of rotation AR of the caster wheel 30 and a ground plane is substantially constant between the forward and reverse positions, as seen by comparing the forward height H1 to the reverse height H2, with a change in height of no more than 5% between the forward and reverse positions. In contrast, the prior art caster wheel 70, which is linked to a fixed swivel structure rather than a pivotable swivel structure, rotates to a caster angle of −9 degrees and significantly changes its height when traveling in the reverse direction 24. While the prior art caster wheel 70 is shown as having a bottom below the bottoms of the caster wheels 30, in practice the bottom of the prior art caster wheel 70 would contact the ground plane and significantly raise up the rear 26 of the vehicle 10, which can negatively affect standing windrows and reduce the clearance height for removal of the header 18, as well as transport deployment. It should therefore be appreciated that the caster wheel 30 incorporated in the caster assembly 16 of the present invention maintains a substantially constant height due to the pivoting of the swivel structure 28 about the pivot axis AP between caster angles θ of equal but opposite magnitude and the constant length L of the swivel arm 36 keeping the caster wheel 30 an equal distance from the vertical line 42 between the forward and reverse positions. The main reason for the relatively small difference in heights H1, H2 exhibited between the forward and reverse positions of a vehicle 10 according to the present invention is attributable to the change in wheelbase WB1, WB2 affecting the weight distribution of the vehicle 10 on the caster wheel 30, but this effect still does not cause the caster wheel 30 to raise the rear 26 of the vehicle 10 as much as a fixed swivel structure 28.

During travel of the vehicle 10, there can be periods where the rear axle 48 is unloaded, usually due to heavy deceleration. When such unloading occurs, the rear 26 of the vehicle 10 can lift until the rear axle 48 is in a full droop condition, causing the caster wheel 30 to swivel about the swivel structure 28 from the −9 degree position into the +9 degree reverse position, despite the vehicle 10 moving in the forward direction 22. This change in position causes the unsprung mass of the vehicle 10 to greatly increase and adversely affects the handling of the vehicle 10.

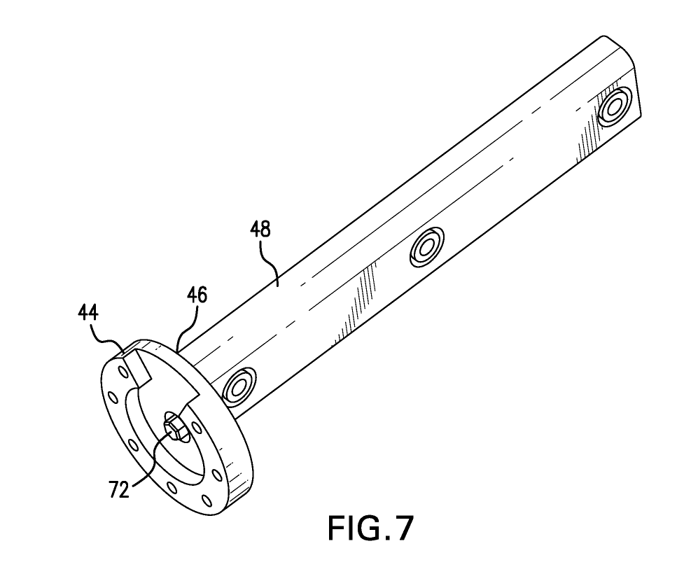

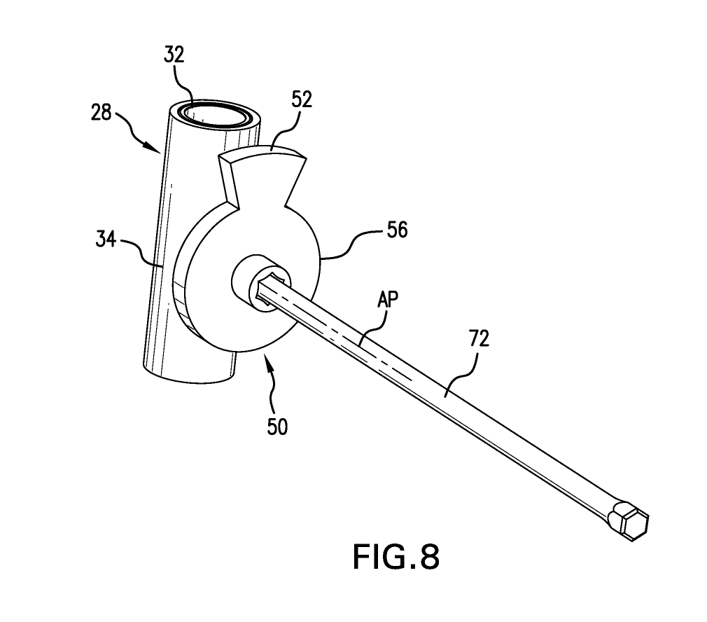

To counteract the effects of the rear axle 48 unloading, and referring now to FIGS. 7 and 8, a torsion element 72 can be connected to the disc 56 of the pivotable element 50, as shown in FIG. 8, to provide a biasing torque that will resist pivoting of the disc 56 within the housing 44 during unloading of the rear axle 48 and keep the caster wheel 30 in the correct −9 degree position during travel in the forward direction 22. The torsion element 72 can be, for example, a torsion bar formed of spring steel that is sufficiently pre-twisted to have a torque that biases the disc 56 clockwise relative to the pivoting axis AP to keep the caster angle θ defined by the swivel structure 28 at −9 degrees. The torsion bar 72 can reside within the tube of the rear axle 48 and be pre-torqued prior to connecting the torsion bar 72 to the disc 56 by twisting the torsion bar 72 about the longitudinal axis of the bar 72. It is useful if the torsion element 72 is preloaded with the minimum torque needed to keep the swivel structure 28 and caster wheel 30 from drooping, in order to avoid providing so much counteracting torque that the swivel structure 28 must overcome to pivot between the −9 and +9 degree positions. For example, the torque that is pre-loaded into the torsion bar 72 can be between 250 and 350 ft-lbs to keep the caster angle θ defined by the swivel structure 28 at −9 degrees. When the torsion bar 72 is formed of a spring steel having a stiffness of around 415 lbs/degree, the torsion bar 72 can be designed with between 0.6 and 0.84 degrees of twisting preload to keep the swivel structure 28 and caster wheel 30 from drooping. It should be appreciated that the previously described values are exemplary only and can be adjusted depending upon the weight distribution and configuration of the vehicle 10. Further, while the torsion element 72 is shown as a torsion bar, other torsion elements can be used such as a rotary damper or friction plate.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A work vehicle, comprising:
a chassis;
a primary wheel carried by said chassis; and
a caster assembly carried by said chassis, said caster assembly including:
a pivotable swivel structure defining a caster angle; and
a caster wheel swivelly linked to said swivel structure and defining a wheelbase relative to said primary wheel, wherein a change in said wheelbase passively causes said swivel structure to pivot and change said caster angle.

2. The work vehicle according to claim 1, wherein said caster assembly further includes a housing and a pivotable element housed within said housing, said swivel structure being pivotable through linkage to said pivotable element.

3. The work vehicle according to claim 2, wherein said housing has a stop surface and said pivotable element includes a stop tab configured to contact said stop surface and prevent pivoting of said pivotable element past said stop surface.

4. The work vehicle according to claim 2, wherein said housing includes a circular pivot groove and said pivotable element includes a disc placed within said pivot groove, said stop tab extending radially away from said disc.

5. The work vehicle according to claim 2, further comprising a torsion element linked to said pivotable element, said torsion element being pre-loaded to resist pivoting of said pivotable element.

6. The work vehicle according to claim 2, further comprising an axle carried by said chassis, said housing being connected to a lateral end of said axle.

7. The work vehicle according to claim 1, wherein said caster wheel is swivelly linked to said swivel structure by a constant length swivel arm connected to said caster wheel and a swivel post connected to said swivel arm that rotates within said swivel structure.

8. The work vehicle according to claim 1, wherein said swivel structure pivots about a pivoting axis between a first caster angle and a second caster angle which is oppositely equal to said first caster angle.

9. The work vehicle according to claim 8, wherein said work vehicle defines a forward travel direction and a reverse travel direction, said swivel structure defining said first caster angle when said work vehicle travels in said forward travel direction and defining said second caster angle when said work vehicle travels in said reverse travel direction.

10. The work vehicle according to claim 8, wherein said caster wheel rotates about a wheel axis defining a height relative to a ground plane, wherein said height is substantially equal when said pivoting structure defines said first caster angle and said second caster angle.

11. The work vehicle according to claim 1, further comprising an axle carried by said chassis, said swivel structure being pivotably connected to a lateral end of said axle.

12. The work vehicle according to claim 1, further comprising a header carried by said chassis at a front of said vehicle.

13. An agricultural vehicle, comprising:
a chassis;
a header carried by said chassis at a front of said vehicle;
a primary wheel carried by said chassis; and
a caster assembly carried by said chassis behind said primary wheel, said caster assembly including:
a pivotable swivel structure carried by said chassis and defining a caster angle; and
a caster wheel swivelly linked to said swivel structure and defining a wheelbase relative to said primary wheel, wherein a change in said wheelbase passively causes said swivel structure to pivot and change said caster angle.

14. The agricultural vehicle according to claim 13, wherein said caster assembly further includes a housing and a pivotable element housed within said housing, said swivel structure being pivotable through linkage to said pivotable element.

15. The agricultural vehicle according to claim 14, wherein said housing has a stop surface and said pivotable element includes a stop tab configured to contact said stop surface and prevent pivoting of said pivotable element past said stop surface.

16. The agricultural vehicle according to claim 13, wherein said caster wheel is swivelly linked to said swivel structure by a constant length swivel arm connected to said caster wheel and a swivel post connected to said swivel arm that rotates within said swivel structure.

17. The agricultural vehicle according to claim 13, wherein said swivel structure pivots about a pivoting axis between a first caster angle and a second caster angle which is oppositely equal to said first caster angle.

18. The agricultural vehicle according to claim 17, wherein said agricultural vehicle defines a forward travel direction and a reverse travel direction, said swivel structure defining said first caster angle when said agricultural vehicle travels in said forward travel direction and defining said second caster angle when said agricultural vehicle travels in said reverse travel direction.

19. The agricultural vehicle according to claim 17, wherein said caster wheel rotates about a wheel axis defining a height relative to a ground plane, wherein said height is substantially equal when said pivoting structure defines said first caster angle and said second caster angle.
